(19) United States
(12) Patent Application Publication
(10) Pub. No.: US 2010/0092746 A1
(43) Pub. Date: Apr. 15, 2010

(54) NONWOVEN MATERIAL CONTAINING BENEFITING PARTICLES AND METHOD OF MAKING

(76) Inventors: Jean-Marie Coant, Saint-Denis (FR); Scott J. Tuman, Woodbury, MN (US); Lahoussaine Lalouch, Oise, Picardie (FR); Carmen Martin Rivera, Madrid (ES)

Correspondence Address: 3M INNOVATIVE PROPERTIES COMPANY, PO BOX 33427, ST. PAUL, MN, 55133-3427, US

(21) Appl. No.: 12/251,048

(22) Filed: Oct. 14, 2008

(51) Int. Cl. D04H 1/00; B24D 3/00; B32B 5/18

(52) U.S. Cl. 428/219; 442/123; 442/59; 442/76; 264/109; 264/101

(57) ABSTRACT

A nonwoven web and method of making a nonwoven web is disclosed. The nonwoven web comprises a plurality of randomly oriented and interconnected cut fibers. At least 10% wt. of the fibers are multicomponent fibers comprising at least a first portion having a first melting point and a second portion having a second melting point. The first melting point is less than the second melting point. Further the nonwoven comprises a plurality of benefiting particles. The first portion of the multicomponent fibers melts and coalesces to secure together the plurality of fibers and secure the benefiting particles to the fibers to form a web.

### BACKGROUND

The present invention relates to a nonwoven cleaning article and methods of making. In particular, the present invention relates to a nonwoven cleaning article that comprises multicomponent fibers for securing benefiting particles to the nonwoven cleaning article.

Nonwoven articles are used extensively in cleaning, abrading, finishing and polishing applications on a variety of surfaces. Nonwoven articles may be a dense, soft, flexible wipe or may be an open, lofty, three dimensional structure of fibers. An example of an open, lofty, three dimensional nonwoven is described in U.S. Pat. No. 2,958,593 to Hoover et al. Such nonwoven webs comprise a suitable fiber such as nylon, polyester, blends thereof and the like and are capable of withstanding temperatures at which impregnating resins and adhesive binders are typically cured. The fibers of the web are often tensilized and crimped but may also be continuous filaments formed by an extrusion process such as that described in U.S. Pat. No. 4,227,350 to Fitzer, for example.

Nonwoven webs can be formed by a variety of techniques including carding, garneting, airlaying, spunbond, wet-laying, melt blowing, and stitchbonding. Further processing of a nonwoven may be necessary to add properties such as strength, durability, and texture. Examples of further processing include calendering, hydroentangling, needletacking, resin bonding, thermobonding, ultrasonic welding, embossing, and laminating.

It is common to add abrasive particles bonded to the fibers of a nonwoven web by a binder coating to provide abrasive articles suitable for use in any of a variety of abrasive applications, and such articles may be provided in the form of endless belts, discs, hand pads, densified or compressed wheels, floor polishing pads and the like.

In the manufacture of these articles, a nonwoven article is first prepared, as mentioned. The nonwoven article is reinforced, for example, by the application of a prebond resin to bond the fibers at their mutual contact points. Additional binder layers may subsequently be applied to the prebonded article. A make coat precursor is applied over the fibers of the prebonded article and the make coat precursor is at least partially cured. A size coat precursor may be applied over the make coat precursor and both the make coat precursor and the size coat precursor are sufficiently hardened in a known manner (e.g., by heat curing). Abrasive particles, when included in the construction of the article, can be applied to the fibers in a slurry with the make coat precursor. The addition of the various resin coatings adds processing steps, time and energy to make the nonwoven article. In addition, the resins are often solvent based, adding to the cost and handling of the material.

### SUMMARY

A nonwoven web is made that contains benefiting particles without the need of a separate binder. In one embodiment, the nonwoven web comprises a plurality of randomly oriented and interconnected cut fibers. At least 10% wt. of the fibers are multicomponent fibers comprising at least a first portion having a first melting point and a second portion having a second melting point. The first melting point is less than the second melting point. Further the nonwoven comprises a plurality of benefiting particles. The first portion of the multicomponent fibers melts and coalesces to secure together the plurality of fibers and secure the benefiting particles to the multicomponent fibers to form a web. In one embodiment, the benefiting particles are distributed throughout the thickness of the web. In another embodiment, the benefiting particles are preferentially on one surface of the web. In one embodiment, the article is essentially free of an additional binder.

In another embodiment, a method of making a nonwoven article comprises providing a forming box having an upper end and a lower end, inserting fibers into the upper end of the forming box. At least 10% wt. of the fibers are multicomponent fibers comprising at least a first portion having a first melting point and a second portion having a second melting point. The first melting point is less than the second melting point. The method further comprises wetting the fibers, inserting benefiting particles into the upper end of the forming box, mixing the fibers and benefiting particles within the forming box, and gravity dropping the fibers and benefiting particles to the lower end of the forming box to form a mat. The benefiting particles cling to the wetted fibers. The method further comprises heating the mat to melt the first portion of the multicomponent fibers so that the first portion of the multicomponent fibers coalesces to secure together the plurality of fibers and secure the benefiting particles to the multicomponent fibers.

In another embodiment, a method of making a nonwoven article comprises providing a forming box having an upper end and a lower end and inserting fibers into the upper end of the forming box. At least 10% wt. of the fibers are multicomponent fibers comprising at least a first portion having a first melting point and a second portion having a second melting point. The first melting point is less than the second melting point. The method further comprises inserting benefiting particles into the upper end of the forming box, mixing the fibers and benefiting particles within the forming box, gravity dropping the fibers and benefiting particles to the lower end of the forming box to form a mat having a density of at least 75 kg/m³, providing a vacuum on a lower side of the mat, opposite the upper side of the mat adjacent the forming box to pull the benefiting particles through the thickness of the web, and heating the mat to melt the first portion of the multicomponent fibers so that the first portion of the multicomponent fibers coalesces to secure together the plurality of fibers and secure the benefiting particles to the multicomponent fibers.

### BRIEF DESCRIPTION OF THE DRAWINGS

FIG. 1 is a perspective view of one embodiment of a nonwoven article;

FIG. 2 is an exploded view of the nonwoven article of FIG. 1.

FIG. 3 is a side view showing a process of making the nonwoven article.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention.

The figures may not be drawn to scale.

### DETAILED DESCRIPTION

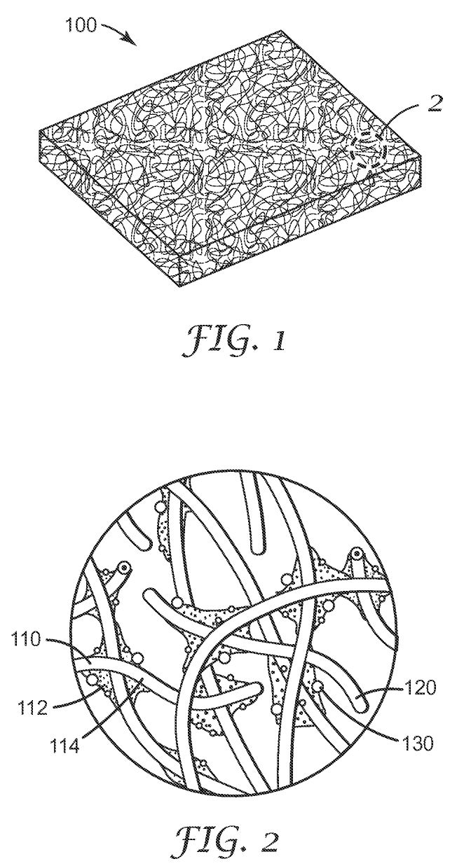

FIG. 1 is a perspective view of one embodiment of a nonwoven article 100. FIG. 2 is an exploded view of the nonwoven article of FIG. 1. The nonwoven article 100 comprises multicomponent fibers 110 and benefiting particles 130. Optionally, the nonwoven article includes filling fibers 120 that are fibers other than multicomponent fibers. Use of the multicomponent fibers allows for securing the fibers together along with the benefiting particles without the need of an additional resin coating.

The multicomponent fibers 110 is a synthetic fiber having at least a first portion 112 and a second portion 114, where the first portion 112 has a melting point lower than the second portion 114. A variety of different types and configurations of multicomponent fibers exist. One example of a multicomponent fiber is a bicomponent fiber. One example of a bicomponent fiber is a sheath/core fiber, where the sheath that surrounds the core forms the first portion 112 and the core forms the second portion 114 of the fiber. The first portion 112 may be comprised of such materials as copolyester or polyethylene. The second portion 114 may be comprised of such materials as polypropylene or polyester.

During heating, the first portion 112 will melt, while the second portion 114 with a higher melting point remains intact. During melting, the first portion 112 tends to collect at junction points where fibers contact one another. Then, upon cooling, the material of the first portion 112 will resolidify to secure the web together. Therefore, it is a portion of the multicomponent fiber 110 that secures the fibers together to form the web 100. There is not a need for a separate binder to form the nonwoven article 100.

Typically, the multicomponent fibers 110 are at least 0.25 inch (0.635 cm) long and have a denier of at least 1. Preferably, the multicomponent fibers 110 are 0.5 inches (1.27 cm) long and have a denier of 2. However, it is understood that the fibers can be as small as the lowest length of fiber that are capable of being cut. One multicomponent fiber 110 including a core and a sheath is Celbond® fibers 254, available from KoSa Co. of Wichita, Kans. where the sheath has a melting point of 110° C.

Other multicomponent polymeric fibers are within the scope of the present inventions. Other multi-component fibers may consist of a layered structure where one layer has a first melting point and another layer has a second melting point lower than the first melting point. In such an arrangement, the layer with the second melting point will melt and resolidify to secure the web together.

By using the process disclosed below, it is possible to utilize the melted first portion 112 of the multicomponent fiber to secure benefiting particles 130 to the multicomponent fiber 110, and therefore to the nonwoven article 100. Therefore, the more multicomponent fibers used in the nonwoven article 100, the higher the possible loading of the benefiting particles 130 to the melted first portion 112 of the multicomponent fiber. In one embodiment, the nonwoven article 100 comprises at least 10% wt. of the total fiber content of multicomponent fibers 110. In another embodiment, the nonwoven article 100 may be comprised entirely of multicomponent fibers 110. In another embodiment, filling fibers 120 are blended with the multicomponent fibers 110. Filling fibers 120 are any kind of fiber other than a multicomponent fiber. Examples of filling fibers 120 include single component synthetic fibers, semi-synthetic fibers, metal fibers, and natural fibers. Synthetic and/or semi-synthetic fibers include those made of polyester (e.g., polyethylene terephthalate), nylon (e.g., hexamethylene adipamide, polycaprolactam), polypropylene, acrylic (formed from a polymer of acrylonitrile), rayon, cellulose acetate, polyvinylidene chloride-vinyl chloride copolymers, vinyl chloride-acrylonitrile copolymers, and so forth. Suitable natural fibers include those of cotton, wool, jute, agave, sisal, coconut, soybean, and hemp. The fiber used may be virgin fibers or waste fibers reclaimed from garment cuttings, carpet manufacturing, fiber manufacturing, or textile processing, for example. The size and amount of filling fibers 120, if included, used to form the nonwoven article 100 will depend on the desired properties (i.e., loftiness, openness, softness, drabability) of the nonwoven article 100 and the desired loading of the benefiting particle.

Generally, the larger the fiber diameter, the larger the fiber length, and the presence of a crimp in the fibers will result in a more open and lofty nonwoven article. Open, lofty nonwoven articles suitable for scouring generally have a maximum density of 60 kg/m³. Generally, small and shorter fibers will result in a more compact nonwoven article. Flexible, drapable and compact nonwoven articles are referred to as wipes and generally have a density greater than 75 kg/m³ and typically greater than 100 kg/m³.

Generally, higher amounts of multicomponent fiber will result in a stiffer and more abrasive nonwoven article. Further, polymer type will also impact the stiffness and abrasiveness of the nonwoven article because different polymers have different hardnesses. A higher hardness of the polymer will create a nonwoven article that has more abrasive action.

The benefiting particles 130 can be any discrete particle, which is a solid at room temperature, added to the nonwoven article to provide a cleaning, scouring, polishing, wiping, absorbing, adsorbing, or sensory benefit to the nonwoven article. In one embodiment, the benefiting particles have size of less than 1 cm in diameter. In other embodiments, the benefiting particles have a size of less than 1 mm in diameter.

Depending on the density of the benefiting particle, size of the benefiting particle, and desired attributes of the final nonwoven, a variety of different loadings, relative to the multicomponent fiber and filling fiber if included, of the benefiting particle may be used. In one embodiment, the benefiting particles comprise less than 90% wt. of the total nonwoven article weight. In one embodiment, the benefiting particles comprise at least 10% wt. of the total nonwoven article weight.

In one embodiment, the benefiting particles 130 are abrasive particles. Abrasive particles are used to create an abrasive nonwoven article 100 that can scour and abrade difficult to remove material during cleaning. Abrasive particles may be mineral particles, synthetic particles, natural abrasive particles or a combination thereof. Examples of mineral particles include aluminum oxide such as ceramic aluminum oxide, heat-treated aluminum oxide and white-fused aluminum oxide; as well as silicon carbide, alumina zirconia, diamond, ceria, cubic boron nitride, garnet, flint, silica, pumice, and calcium carbonate. Synthetic particles include polymeric materials such as polyester, polyvinylchloride, methacrylate, methylmethacrylate, polycarbonate, melamine, and polystyrene. Natural abrasive particles include nutshells such as walnut shell, or fruit seeds such as apricot, peach, and avocado seeds.

Various sizes, hardness, and amounts of abrasive particles may be used to create an abrasive nonwoven article 100 ranging from very strong abrasiveness to very light abrasiveness. In one embodiment, the abrasive particles have a size greater than 1 mm in diameter. In another embodiment, the abrasive particles have a size less than 1 cm in diameter. In one embodiment, a combination of particles sizes and hardness can be used to give a combination of abrasiveness that is strong without scratching. In one embodiment, the abrasive particles include a mixture of soft particles and hard particles.

In one embodiment, the benefiting particles 130 are metal. The metal particles may be used to create a polishing nonwoven article 100. The metal particles may be in the form of short fiber or ribbon-like sections or may be in the form of grain-like particles. The metal particles can include any type of metal such as but not limited to steel, stainless steel, copper, brass, gold, silver (which has antibacterial/antimicrobial properties), platinum, bronze or blends of one or more of various metals.

In one embodiment, the benefiting particles 130 are solid materials typically found in detergent compositions, such as surfactants and bleaching agents. Examples of solid surfactants include sodium lauryl sulfate and dodecyl benzene sulfonate. Other examples of solid surfactants can be found in “2008 McCutcheon's Volume I: Emulsifiers and Detergents (North American Edition)” published by McCuthcheon's Division. Examples of solid bleaching agents include inorganic perhydrate salts such as sodium perborate mono- and tetrahydrates and sodium percarbonate, organic peroxyacids derivatives and calcium hypochlorite.

In one embodiment, the benefiting particles 130 are solid biocides or antimicrobial agents. Examples of solid biocide and antimicrobial agents include halogen containing compounds such as sodium dichloroisocyanurate dihydrate, benzylkoniumchloride, halogenated dialkylhydantoins, and triclosan.

In one embodiment, the benefiting particles 130 are microcapsules. Microcapsules are described in U.S. Pat. No. 3,516,941 to Matson and include examples of the microcapsules that can be used as the benefiting particles 130. The microcapsules may be loaded with solid or liquid fragrance, perfume, oil, surfactant, detergent, biocide, or antimicrobial agents. One of the main qualities of a microcapsule is that by means of mechanical stress the particles can be broken in order to release the material contained within them. Therefore, during use of the nonwoven article 100, the microcapsules will be broken due to the pressure exerted on the nonwoven article 100, which will release the material contained within the microcapsule.

In one embodiment, the benefiting particles 130 are adsorbent or absorbent particles. For example, adsorbent particles could include activated carbon, charcoal, sodium bicarbonate. For example, absorbent particle could include porous material, natural or synthetic foams such as melamine, rubber, urethane, polyester, polyethylene, silicones, and cellulose. The absorbent particle could also include superabsorbent particles such as sodium polyacrylates, carboxymethyl cellulose, or granular polyvinyl alcohol. The adsorbent or absorbent particles may have a size greater than 1 mm in diameter in one embodiment. In another embodiment, the adsorbent or absorbent particle may have a size less and 1 cm in diameter. In one embodiment, at least 50% wt. of the entire nonwoven article is an absorbent foam. In another embodiment, at least 75% wt. of the entire nonwoven article is an absorbent foam. In another embodiment, at least 90% wt. of the entire nonwoven article is an absorbent foam.

In one embodiment, the benefiting particle is a chopped cellulose sponge. In such an embodiment, at least 75% wt. of the entire nonwoven article is the chopped cellulose sponge. It has been found that a nonwoven article with cellulose sponge benefiting particles is a highly hydrophilic, absorbent article. In addition, a nonwoven article with cellulose sponge benefiting particles remains flexible and drapable even following drying. Typically, cellulose sponge products become rigid and less flexible upon drying.

It is understood that any combination of one or more of the above described benefiting particles 130 may be used within the nonwoven article 100.

Although it is the first portion 112 of the multicomponent fiber 110 that secures the fibers 110, 120 and the benefiting particle 130 together, an optional binder coating may be included following the formation of the nonwoven article 100. This optional binder coating may provide further strength to the nonwoven article, may further secure the benefiting particles to the fibers, and/or may provide additional stiffness for an abrasive or scouring article. The binder coating may be applied by known processing means such as roll coating, spray coating, and immersion coating and combinations of these coating techniques. The binder coating may include additional benefiting particle 130 within the binder or additional benefiting particles 130 may be incorporated and secured to the binder.

The binder may be a resin. Suitable resins include phenolic resins, polyurethane resins, polyureas, styrene-butadiene rubbers, nitrile rubbers, epoxies, acrylics, and polyisoprene. The binder may be water soluble. Examples of water soluble binders include surfactants, polyethylene glycol, polyvinylpyrrolidones, polylactic acid (PLA), polyvinylpyrrolidone/vinyl acetate copolymers, polyvinyl alcohols, carboxymethyl celluloses, hydroxypropyl cellulose starches, polyethylene oxides, polyacrylamides, polyacrylic acids, cellulose ether polymers, polyethyl oxazolines, esters of polyethylene oxide, esters of polyethylene oxide and polypropylene oxide copolymers, urethanes of polyethylene oxide, and urethanes of polyethylene oxide and polypropylene oxide copolymers.

It is understood that a variety of products can be made from the nonwoven articles containing various benefiting particles. Open, lofty scouring products for cleaning could include metal (polishing), abrasive particles, surfactant or detergents, or a combination, for aiding in cleaning. Dense and drapable wiping products could include absorbents, abrasive particles, surfactants or detergents, and antimicrobials. Filters, respirators, diapers or insulation could include absorbent or adsorbent particles.

Through the process described below, it is possible to obtain the benefiting particles preferentially on one surface of the nonwoven article. For open, lofty nonwoven webs, the benefiting particles will fall through the web and preferentially be on the bottom of the nonwoven article. For dense nonwoven webs, the benefiting particles will remain on the surface and preferentially be on the top of the nonwoven article.

Further, as described below, it is possible to obtain a distribution of the benefiting particles throughout the thickness of the nonwoven article. In this embodiment, the benefiting particle therefore is available on both working surfaces of the web and throughout the thickness. In one embodiment, the fibers can be wetted to aid in the clinging the benefiting particle to the fibers until the fiber can be melted to secure the benefiting particles. In another embodiment, for dense nonwoven webs, a vacuum can be introduced to pull the benefiting particles throughout the thickness of the nonwoven article.

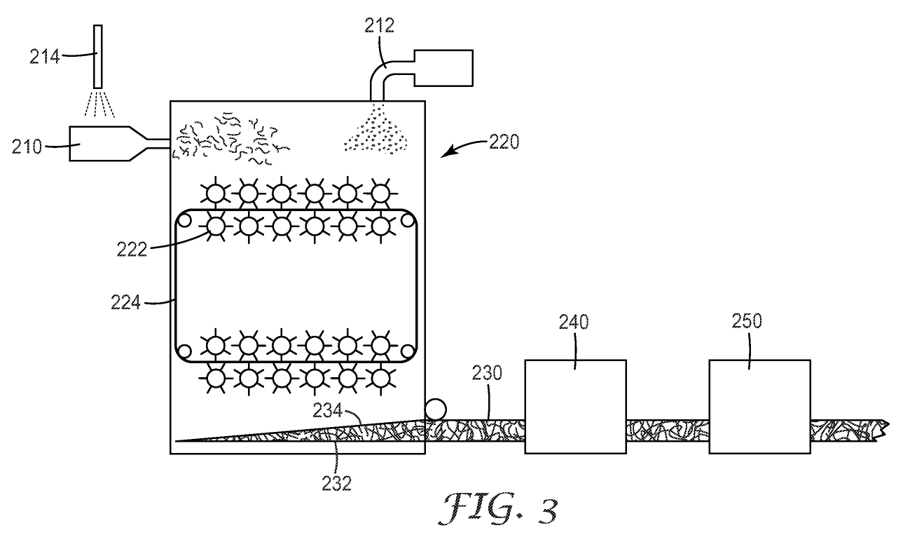

FIG. 3 is a side view showing the process 200 of making the nonwoven article 100 discussed above. A fiber input stream 210 extends up a conveyer to the top of a forming box 220 where the fibers are mixed, blended, and ultimately form a mat 230. Prior to entering the forming box 220, an opener (not shown) may be included to open, comb, and/or blend the input fibers, particularly if a blend of multicomponent 110 and filling fibers 120 are included. Also, entering the top of the forming box 220 is a benefiting particle input stream 212. It is understood that the benefiting particle input stream 212 may be introduced at other portions of the forming box 220. For example the benefiting particle input stream 212 can be introduced in the middle or at the bottom of the forming box 220.

The forming box 220 is a type of air-laying fiber processing equipment, such as shown and described in US Patent Application Publication 2005/0098910 titled “Fiber distribution device for dry forming a fibrous product and method,” the disclosure of which is herein incorporated by reference. Instead of using strong air flow to mix and interengaged the fibers to form a mat (such as with a “RandoWebber” web forming machine, available from Rando Machine Corporation, Macedon, N.Y.), the forming box 220 has spike rollers 222 to blend and mix the fibers while gravity allows the fibers to fall down through the endless belt screen 224 and form a mat or web 230 of interengaged fibers. With this construction of air-laying equipment, the fibers and the benefiting particles are falling together to the bottom of the forming box 220 to form the mat 230. In one embodiment, a vacuum can be included below the area where the mat 230 forms in the forming box 220.

The formed mat 230 exits the forming box 220 and proceeds to a heating unit 240, such as an oven, to heat the first portion 112 of the multicomponent fiber 110. The melted first portion 112 tends to migrate and collect at points of intersection of the fibers of the mat 230. Then, upon cooling, the melted first portion 112 coalesces and solidifies to create a secured, interconnected nonwoven article 100.

The benefiting particles 130 are also secured to the nonwoven article 100 by the melted and then coalesced first portion 112 of the multicomponent fiber 110. Therefore, in two steps, first forming the web and then heating the web, a nonwoven web containing benefiting particles 130 can be created without the need for binders or further coating steps.

In one embodiment, the benefiting particles 130 fall through the fibers of the mat 230 and are therefore preferentially on a lower surface 232 of the mat 230. When the mat proceeds to the heating unit 240 the melted and then coalesced first portion 112 of the multicomponent fibers 110 located on the lower surface of the mat 230 secures the benefiting particles 130 to the mat 230, without the need for an additional binder coating.

In another embodiment, when the mat is a relatively dense web with small openings, the benefiting particles 130 remain preferentially on a top surface 234 of the mat 230. In such an embodiment, a gradient may form of the particles partially falling through some of the openings of the web. When the mat 230 proceeds to the heating unit 240, the melted and then coalesced first portion 112 of the multicomponent fibers 110 located on the top surface of the mat 230 secures the benefiting particles 130 to the mat 230, without the need for an additional binder coating.

In another embodiment, a liquid solution 214, such as an aqueous solution, is introduced as a mist 214. The liquid solution 214 wets the fibers so that the benefiting particles cling to the surface of the fibers. Therefore, the benefiting particles are generally dispersed throughout the thickness of the mat 230. When the mat 230 proceeds to the heating unit 240, the liquid solution 214 evaporates while the first portion 112 of the multicomponent fiber melts. The melted and then coalesced first portion 112 of the multicomponent fiber secures the fibers of the mat 230 together and secures the benefiting particles to the mat 230, without the need for an additional binder coating.

The mist 214 is shown wetting the fibers 110 and 120, if included, prior to the fibers being introduced into the forming box 220. However, wetting of the fibers could occur at other locations in the process. For example, liquid may be introduced at the bottom of the forming box 220 to wet the mat 230 while the benefiting particles 130 are being dropped. The mist 214 could be introduced at the top of the forming box 220 or in the middle of the forming box 220 to wet the benefiting particles and fibers prior to dropping.

It is understood that the benefiting particles 130 chosen must be capable of withstanding the heat that the mat 230 is exposed to in order to melt the first portion 112 of the multicomponent fiber 110. Generally, the heat is at 100 to 150° C. Further, it is understood that the benefiting particles 130 chosen must be capable of withstanding the mist of liquid solution 214, if included. Therefore, the liquid of the mist may be an aqueous solution, and in another embodiment, the liquid of the mist may be an organic solvent solution.

Following formation of the mat 230 and then heating through the heating unit 240, which melts and then coalesces the first portions to secure the mat 230 and secure the benefiting particle, an optional binder coating could be included. The mat 230 could proceed to a coater 250 where a liquid or dry binder could be applied. The coater 250 could be a roller coater, spray coater, immersion coater, powder coater or other known coating mechanism. The coater 250 could apply the binder to a single surface of the mat 230 or to both surfaces. If applied to a single surface, the mat 230 may proceed to another coater (not shown), where the other uncoated surface could be coated with a binder. It is understood that if a binder coating is included, that the benefiting particle should be capable of withstanding the coating process and conditions.

Other post processing steps may be done to add strength or texture to the nonwoven article 100. For example, the nonwoven article 100 may be needle punched, calendared, hydroentangled, embossed, or laminated to another material.

Although specific embodiments of this invention have been shown and described herein, it is understood that these embodiments are merely illustrative of the many possible specific arrangements that can be devised in application of the principles of the invention. Numerous and varied other arrangements can be devised in accordance with these principles by those of ordinary skill in the art without departing from the spirit and scope of the invention. Thus, the scope of the present invention should not be limited to the structures described in this application, but only by the structures described by the language of the claims and the equivalents of those structures.

### EXAMPLES

### Example #1

### Open, Lofty Nonwoven Web with Benefiting Particles Preferentially on One Surface of the Web

The following materials were introduced into the fiber input stream 210 and the benefiting particle input stream 212 as shown in FIG. 3:

A) Sheath/core bicompoent fiber CoPET/PET, wherein the sheath melts at 120° C., (size=2.54 cm length, 20 denier) from Fiber Innovation Technology (Johnson City, Tenn., USA)
B) Polyethylene Fiber (size=1.27 cm length, 5 denier) from Minifibers, Inc. (Johnson City, Tenn., USA)
C) FRPL Semi-Friable Fused Aluminum Oxide Abrasive Powder (size=40 micron) from Treibacher-Schleifm (Villach, Austria)

Each material was introduced in a controlled manner to yield the following weights:

A=160 g/m² (gsm)

### B=40 gsm

### C=150 gsm

The materials were opened and fluffed in the top of the forming box 220 and then allowed to fall through the spike rollers 222 and endless belt screen 224 to the bottom and formed a web 230 on the collection belt. The materials were pulled down by a combination of gravity and vacuum. The web 230 was then conveyed into an oven 240 (140-150° C.), which melts the sheath of component A and the entire fiber of component B. In this example, the web 230 was removed immediately after the oven 240. The resulting web was an open, lofty web and was visually observed to have abrasive particles on only one side and exhibited scouring performance on only that side.

### Example #2

### Open, Lofty Nonwoven Web with Benefiting Particles Distributed Throughout Thickness of the Web

In Example #2 the same procedure was used except that the fibers (components A and B) were sprayed with water before entering the forming box 220. The resulting web was an open, lofty web, and was visually observed to have a generally uniform distribution of abrasive particles throughout the thickness of the web and exhibited scouring performance on both sides of the web.

### Example #3

### Dense Nonwoven Web with Benefiting Particles

The following materials were introduced into the fiber input stream 210 and the benefiting particle input stream 212 as shown in FIG. 3:

A) viscose fiber, 1.27 cm length
B) Sheath/core bicompoent fiber CoPET/PET, wherein the sheath melts at 120° C., (size=1.27 cm length, 2 denier)
C) melamine powder, Blast Media Poly Bead—product # 22020″ size=20/30 grit, from Eastwood Company (Pottstown, Pa.)

Each material was introduced in a controlled manner to yield the following weights:

### A=150 gsm

### B=50 gsm

### C=200 gsm

The materials were introduced into the top of the forming box 220 and then allowed to fall through the spike rollers 222 and endless belt screen 224 to the bottom and formed a web 230 on the collection belt. The materials were pulled down by a combination of gravity and vacuum. The web 230 was then conveyed into an oven 240 (140-150° C.), which melts the sheath of component B. In this example, the web 230 was removed immediately after the oven 240. The resulting web was a dense, drapable web and was visually observed to have most of the abrasive particles on the bottom side and a few abrasive particles throughout the thickness of the web. The web was flexible and drapable.

### Example #4

### Flexible, Drapable Cellulose Sponge Cloth

The following materials were introduced to the fiber input stream 210 as shown in FIG. 3:

A) Shredded Cellulose Sponge (avg. size=3-4 mm), sponge from 3M Company (St. Paul, Minn., USA)
B) Sheath/core bicomponent PE/PET, wherein the sheath melts at 110° C. (size=12 mm length×1.3 denier) from Trevira (Frankfurt, Ga.)
C) Sheath/core bicomponent PE/PET, wherein the sheath melts at 110° C. (size=6 mm length×1.3 denier) from Trevira (Frankfurt, Ga.)

Each material was introduced in a controlled manner to yield the following weights:

### A=450 gsm

### B=25 gsm

### C=25 gsm

The materials were opened and fluffed in the top of the forming box 220 and then allowed to fall through the spike rollers 222 and endless belt screen 224 to the bottom and formed a web 230 on the collection belt. The materials were pulled down by a combination of gravity and vacuum. The web 230 was then conveyed into an oven 240 (165° C.), which melts the sheath of both component B and component C. The web 230 then proceeded through a smooth, heated (surface temperature=155° C.) calendar with a 3 mm gap. The resulting web was mechanically strong, drapable, and soft. The resulting web was absorbent and maintained its flexibility even after several times of rinsing and drying.

What is claimed is:

1. A nonwoven article comprising:
a plurality of randomly oriented and interconnected cut fibers, at least 10% wt. of the fibers are multicomponent fibers comprising at least a first portion having a first melting point and a second portion having a second melting point, wherein the first melting point is less than the second melting point;
a plurality of benefiting particles;
wherein the first portion of the multicomponent fibers melts and coalesces to secure together the plurality of fibers and secure the benefiting particles to the fibers to form a web.

2. The nonwoven article of claim 1, wherein 100% wt. of the fibers are multicomponent fibers.

3. The nonwoven article of claim 1, wherein at least 10% wt. of the nonwoven article comprises benefiting particles.

4. The nonwoven article of claim 1, wherein the benefiting particles are selected from the group consisting of abrasive particles, metal particles, detergent particles, surfactant particles, biocide particles, adsorbent particles, absorbent particles, microcapsules, and combinations thereof.

5. The nonwoven article of claim 1, wherein the benefiting particles are foam particles.

6. The nonwoven article of claim 5, wherein at least 75% wt. of the nonwoven articles comprise foam particles.

7. The nonwoven article of claim 1, further comprising a binder coating covering at least a portion of the web.

8. The nonwoven article of claim 1, wherein the web is essentially free of any additional binder.

9. The nonwoven article of claim 1, wherein the benefiting particles are distributed throughout the thickness of the web.

10. The nonwoven article of claim 1, wherein the benefiting particles are preferentially on one surface of the web.

11. The nonwoven article of claim 1, wherein the web is open and lofty and has a maximum density of 60 kg/m³ with the benefiting particles distributed throughout the thickness of the web.

12. A method of making a nonwoven article comprising:
providing a forming box having an upper end and a lower end;
introducing fibers into the upper end of the forming box, wherein at least 10% wt. of the fibers are multicomponent fibers comprising at least a first portion having a first melting point and a second portion having a second melting point, wherein the first melting point is less than the second melting point;
wetting the fibers;
introducing benefiting particles into the upper end of the forming box;
mixing the fibers and benefiting particles within the forming box;
gravity dropping the fibers and benefiting particles to the lower end of the forming box to form a mat, wherein the benefiting particles cling to the wetted fibers;
heating the mat to melt the first portion of the multicomponent fibers so that the first portion of the multicomponent fibers coalesces to secure together the plurality of fibers and secure the benefiting particles to the multicomponent fibers.

13. The method of claim 12, further comprising coating a binder on at least one surface of the mat.

14. A method of making a nonwoven article comprising:
providing a forming box having an upper end and a lower end;
introducing fibers into the upper end of the forming box, wherein at least 10% wt. of the fibers are multicomponent fibers comprising at least a first portion having a first melting point and a second portion having a second melting point, wherein the first melting point is less than the second melting point;
inserting benefiting particles into the upper end of the forming box;
mixing the fibers and benefiting particles within the forming box;
gravity dropping the fibers and benefiting particles to the lower end of the forming box to form a mat having a density of at least 75 kg/m³;
providing a vacuum on a lower side of the mat, opposite the upper side of the mat adjacent the forming box to pull the benefiting particles through the thickness of the web;
heating the mat to melt the first portion of the multicomponent fibers so that the first portion of the multicomponent fibers coalesces to secure together the plurality of fibers and secure the benefiting particles to the multicomponent fibers.

15. The method of claim 14, further comprising coating a binder on at least one surface of the mat.
